(19) United States
(12) Patent Application Publication
(10) Pub. No.: US 2023/0191865 A1
(43) Pub. Date: Jun. 22, 2023

(54) AIRSPRING GAITER WITH SLIDING JOINT

(71) Applicant: Continental Automotive Systems, Inc., Auburn Hills, MI (US)

(72) Inventors: Garrett Mark Pniewski, Bloomfield Hills, MI (US); Joseph G Jerisk, Burton, MI (US)

(73) Assignee: Continental Automotive Systems, Inc., Auburn Hills, MI (US)

(21) Appl. No.: 17/645,063

(22) Filed: Dec. 20, 2021

(51) Int. Cl. B60G 15/14; F16F 9/05; F16F 9/54

(52) U.S. Cl. CPC B60G 15/14; F16F 9/05; F16F 9/54; B60G 2202/314; B60G 2204/1262; B60G 2202/152

(57) ABSTRACT

An air spring assembly including sliding joint providing a gaiter sliding upward or downward as a vehicle displaces the air spring assembly. The air sprig assembly includes a damper, a piston connected to the damper, a gaiter surrounding the piston and a portion of the damper, and a dampening ring connected to the gaiter.

### BACKGROUND

### 1. Field

The present application relates to a chassis and air suspension of a motor vehicle, and more particularly to an air sprig over damper or air strut and guided free standing air spring of a motor vehicle.

### 2. Description of Related Art

Suspension systems for automotive vehicles provide vehicle passengers with a more comfortable ride. Air suspension systems utilize air springs, rather than traditional coil springs, and provide different suspension qualities that may be preferable in some vehicles to traditional coil spring suspensions.

A conventional air spring is a device that is arranged between a vehicle body and chassis. The typical air spring has at least one working space, or cavity that is filled with compressed air. Space constraints can limit the amount of working space for the air spring assembly, especially as vehicles are designed with increasingly tighter space constraints.

One component of an air spring is a gaiter, which provides protection to components of the air spring including a piston and damper. The gaiter may be configured as a sawtooth gaiter with or without special folds, a rubber/EPDM material that folds in reverse of the airspring bellow, a stretchy elastic gaiter, and multiple corrugated gaiters working in conjunction.

There exists a need for an air spring assembly with reduced total compressed height, and thus an improved gaiter for reducing the total compressed height of the air spring.

### SUMMARY

Aspects of embodiments of the present application relate to an airspring gaiter with a sliding joint. According to aspects of the embodiments, displacement of the gaiter may be significantly reduced, therefore reducing the size, packaging space and cost of the gaiter and the air spring assembly. The reduced cost of a smaller gaiter and increased flexibility for packaging may provide an improved air spring assembly.

According to an aspect of an embodiment, there is provided an air spring assembly including a damper, a piston connected to the damper, a gaiter surrounding the piston and a portion of the damper, and a dampening ring connected to the gaiter.

### BRIEF DESCRIPTION OF THE DRAWINGS

The above and other aspects will be more clearly understood from the following brief description taken in conjunction with the accompanying drawings, in which:

FIG. 1 is a perspective view of an air spring assembly, according to an embodiment;

FIGS. 2A and 2B illustrate a dampening ring, according to an embodiment; and

FIG. 3 is an exploded view of the air spring assembly of FIG. 1.

### DETAILED DESCRIPTION

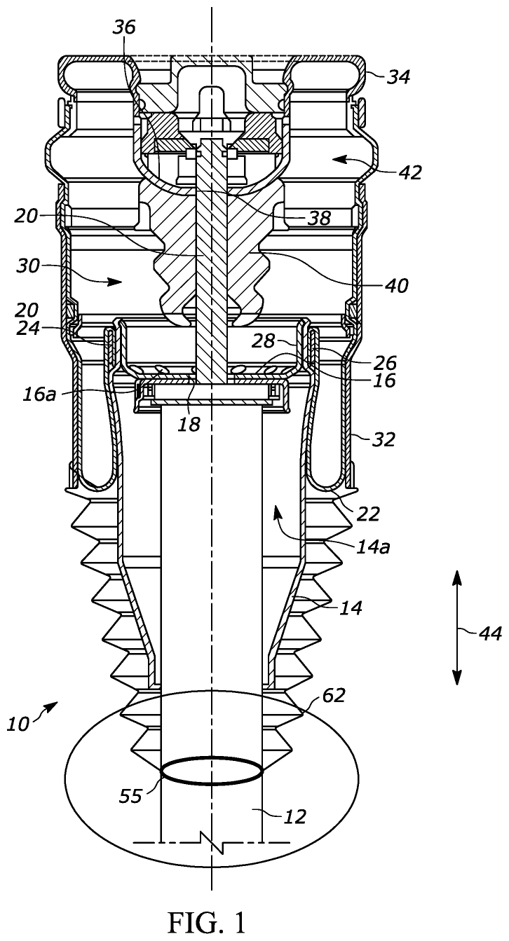

FIG. 1 is a perspective sectional view of an air spring assembly, according to an embodiment.

As illustrated in FIG. 1, the air spring 10 includes a damper body 12 and a piston 14, 16. The piston 14, 16 may include an outer piston 14 surrounding a portion of the damper body 12. The outer piston 14 may be connected to an inner piston 16, which is also connected to the damper body 12. The inner piston 16 includes an aperture 18. A damper rod 20 extends through the aperture 18.

The air spring 10 also includes a bellow 22, which is flexible and able to change shape as the piston 14,16 is moved relative to the damper rod 20. A free end 24 of the bellow 22 is clamped between a clamping ring 26 and a portion of the outer piston 14, and is adjacent a flange portion 28 of the inner piston 16.

The bellow 22 may include a cavity 30, which is generally filled with air. The cavity 30 of the bellow 22 is in fluid communication with a cavity 14a formed as part of the outer piston 14. The cavity 30 is in fluid communication with the cavity 14a through several apertures 16a formed as part of the inner piston 16.

The bellow 22 is partially surrounded by a guide tube 32. The guide tube 32 and the bellow 22 are connected to a top cap 34. The top cap 34 includes a base portion 36. The damper rod 20 extends through an aperture 38 in the base portion 36. The damper rod 20 also extends through a jounce bumper 40, which is partially surrounded by, and connected, to the top cap 34.

The top cap 34 also has a cavity 42, which is in fluid communication with the cavity 30 of the bellow 22 and the cavity 14a of the inner piston 14, such that the cavities 14a, 30, 42 function collectively as a single volume.

The top cap 28 is connected to another component of the vehicle, such the frame of the vehicle, but the top cap 28 may be connected to other components of the vehicle. Additionally, the damper body 12 is connected to another part of the suspension system of the vehicle, such as an A-arm, or swing arm. As the A-arm moves from (operation of the vehicle) the damper body 12 and piston 14 move in either of the directions indicated by arrow 44 relative to the damper rod 20.

The air spring assembly 10 also includes a flexible outer cover, which may be a gaiter 62. The gaiter 62 flexes and moves as the damper body 12 and piston 14, 16 move during travel of the vehicle. The gaiter 62 may be an EPDM/rubber gaiter or a corrugated fold gaiter, and the gaiter 62 may provide protection from debris to the damper 12 and piston 14.

As illustrated in FIG. 1, a dampening ring 55 is disposed on the damper 12. Accordingly, the dampening ring 55 may be disposed between the damper 12 and the gaiter 62. The dampening ring 55 may be an NBR/rubber noise dampening ring. An inner diameter of the dampening ring 55 may be substantially equal to, but slightly larger than, an outer diameter of the damper 12. Accordingly, the dampening ring 55 may be said to slide upwards or downwards along the outer surface of the damper 12.

Alternatively, the dampening ring 55 may be disposed on the piston 14, Accordingly, the dampening ring may be disposed between the piston 14 and the gaiter 62. An inner diameter of the dampening ring 55 may be substantially equal to, but slightly larger than, an outer diameter of at least a portion of the piston 14. Accordingly, the dampening ring 55 may be said to slide upwards or downwards along the outer surface of the piston 14.

In an embodiment, an inner diameter of the dampening ring 55 may be selected to slide upwards or downwards both damper 12 and a portion of the piston 14. In a configuration in which the piston 14 is configured to have a tapered shape, as illustrated in FIG. 1, the inner diameter of the dampening ring 55 may be selected to permit the dampening ring 55 to slide upwards a predetermined distance until the inner diameter of the dampening ring 55 contacts the piston 14 at which the outer diameter of the piston 14 is equal to the inner diameter of the dampening ring 55.

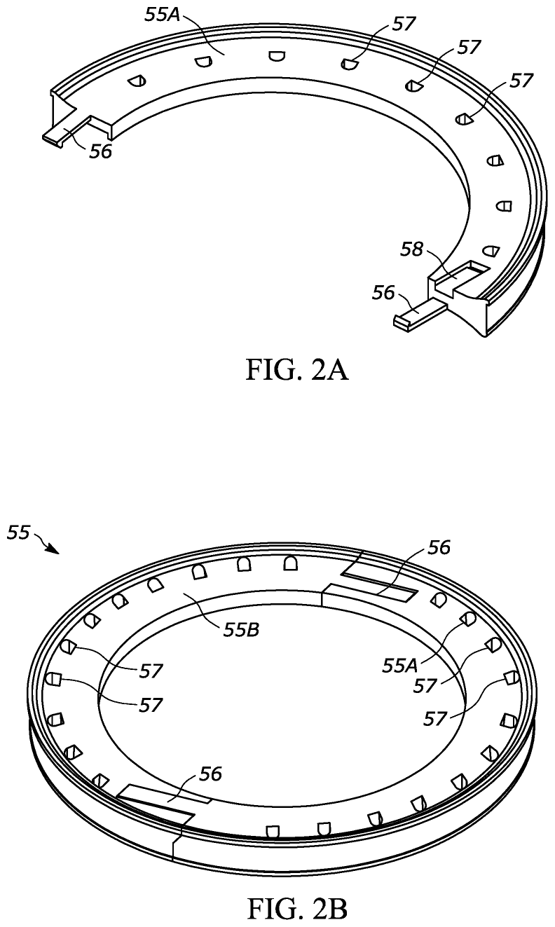

FIGS. 2A and 2B illustrate a dampening ring, according to an embodiment.

As illustrated in FIGS. 2A-B, the dampening ring 55 may be a two-piece plastic sliding ring, which may be held together with snap finger or clip 56.

The gaiter 62 may be disposed over the dampening ring 55. The gaiter 62 may be secured to the dampening ring 55 with a damp, cable tie, or other coupling mechanism. Accordingly, a combination of the gaiter 62 coupled to the dampening ring 55 may be displaced upward or downward along the damper 12 or piston 14, as indicated at 44 in FIG. 1.

Venting of air through the dampening ring 55 is achieved with “church window” openings 57 in the dampening ring 55. The openings 57 may be disposed about a circumference of the dampening ring 55. The openings 57 may fluidly couple a top surface of the dampening ring 55 and a bottom surface of the dampening ring 55. Accordingly, venting of air (between the gaiter 62 and the damper 12 or piston 14) through the dampening ring 55 may occur while the combination of the gaiter 62 coupled to the dampening ring 55 is displaced upward or downward along the damper 12 or piston 14, as indicated at 44 in FIG. 1.

As illustrated in FIGS. 2A-B, the dampening ring 55 includes the snap clips 56 and venting windows 57. In FIG. 2B, the dampening ring 55 includes two rings 55A, 55B assembled together via the snap clip 56 and a corresponding snap recess 58. Although the embodiments illustrated in FIGS. 2A-B illustrate half-rings, the dampening ring 55 may be configured as a single ring, two half-rings, or more partial rings.

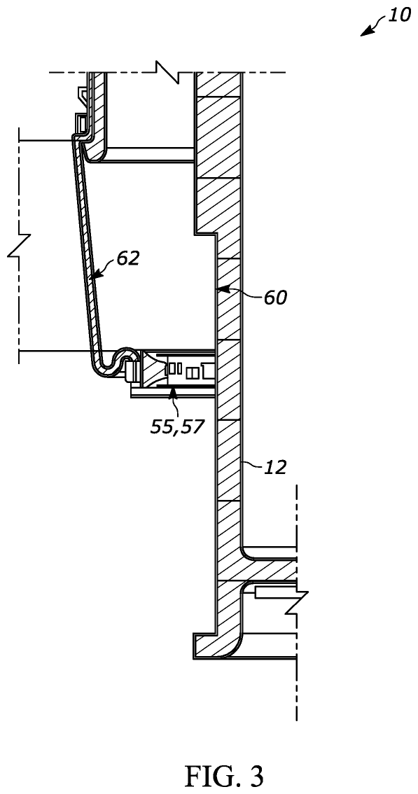

FIG. 3 is an exploded view of the air spring assembly illustrated in FIG. 1.

As illustrated in FIG. 3, the airspring assembly 10 includes a gaiter 62, a dampening ring 55 coupled to the gaiter 62, and a sliding zone 60 on the damper 12. The combination of the gaiter 62 and the dampening ring 55 may be displaced upward or downward in the sliding zone 60 along the damper 12. Although FIG. 3 illustrates the dampening ring 55 disposed along the damper 12, the dampening ring 55 may be disposed along the piston 14, such that the gaiter 62 may be displaced upward or downward in the sliding zone 60 along the piston 14.

The air spring assembly solves a packaging problem of an airspring gaiter with very small or negative packaging space for the gaiter block height. Due to the disposition of the dampening ring 55 over the damper 12 or the piston 14 as a sliding joint, the gaiter 62 may displace upward or downward on either the damper 12 or the piston 14. As a result, the total stroke of the gaiter 62 is significantly reduced or eliminated, and such reduced travel also allows a smaller cost of the gaiter 62.

1. An air spring assembly comprising:
a damper;
a piston connected to the damper;
a gaiter surrounding the piston and a portion of the damper; and
a dampening ring connected to the gaiter.

2. The air spring assembly according to claim 1, wherein the dampening ring is disposed around the piston. The air spring assembly according to claim 2, wherein a combination of the gaiter connected to the dampening ring is configured to slide upwards and downwards along the piston.

4. The air spring assembly according to claim 3, wherein the dampening ring comprises:
a first half-ring comprising a first snap and a first snap recess; and
a second half-ring comprising a second snap coupled to the first snap recess and a second snap recess coupled to the first snap.

5. The air spring assembly according to claim 3, wherein the dampening ring comprises a plurality of openings.

6. The air spring assembly according to claim 5, wherein the plurality of openings comprises a plurality of church window openings.

7. The air spring assembly according to claim 1, wherein the dampening ring is disposed around the damper.

8. The air spring assembly according to claim 7, wherein a combination of the gaiter connected to the dampening ring is configured to slide upwards and downwards along the damper.

9. The air spring assembly according to claim 8, wherein the dampening ring comprises:
a first half-ring comprising a first snap and a first snap recess; and
a second half-ring comprising a second snap coupled to the first snap recess and a second snap recess coupled to the first snap.

10. The air spring assembly according to claim 8, wherein the dampening ring comprises a plurality of openings.

11. The air spring assembly according to claim 10, wherein the plurality of openings comprises a plurality of church window openings.

12. The air spring assembly according to claim 1 wherein the dampening ring is disposed around the piston or around the damper.
